(19) United States
(12) Patent Application Publication
(10) Pub. No.: US 2013/0129980 A1
(43) Pub. Date: May 23, 2013

(54) PROCESS FOR SCRATCH- AND ABRASION-RESISTANT COATING AND PHYSICAL MATTING OF PLASTICS SUBSTRATES, MORE PARTICULARLY POLYMETHYL METHACRYLATE, WITH NANOCOMPOSITE COATING MATERIAL

(71) Applicants: Deiter Meinhard, Leipzig (DE); Rolf Schubert, Trebsen (DE); Evelin Bilz, Borsdorf (DE); Sandra Reemers, Muenster (DE)

(72) Inventors: Deiter Meinhard, Leipzig (DE); Rolf Schubert, Trebsen (DE); Evelin Bilz, Borsdorf (DE); Sandra Reemers, Muenster (DE)

(73) Assignee: Evonik Roehm GmbH, Darmstadt (DE)

(21) Appl. No.: 13/812,946

(22) PCT Filed: Mar. 28, 2011
(86) PCT No.: PCT/EP2011/054681

§ 371 Date: Jan. 29, 2013

(30) Foreign Application Priority Data
Jul. 29, 2010 (DE) 10 2010 038 617.0

(51) Int. Cl. B05D 5/02

(52) U.S. Cl. CPC B05D 5/02
USPC 428/152; 427/553; 427/508; 524/523

(57) ABSTRACT

The invention relates to a process for the surface-finishing of plastics substrates, preferably polymethyl methacrylate (abbreviated hereinafter to PMMA), by coating with a clear coating material comprising nanoparticles (hereinafter nanocomposite coating material) and irradiating the same with vacuum UV light of wavelength 172 nm from an Xe* excimer lamp. This process leads to excellent adhesion of the coating substance on the substrate. It is moreover possible to give the coating surface a topography. The mechanical and chemical properties and performance characteristics of uncoated substrate are substantially exceeded when a substrate is coated in this way.

### FIELD OF THE INVENTION

The invention relates to a method for the surface finishing of plastic substrates, in particular polymethyl methacrylate (hereinafter PMMA for short), by coating with a nanoparticle-containing coating agent, preferably a clear coating agent, (nanocomposite coating agent hereinafter) and irradiation thereof with vacuum UV light with a wavelength of 172 nm from an Xe* excimer lamp. This method results in excellent adhesion of the coating material to the substrate. Furthermore, the generation of a topography with matt appearance and appealing tactility of the coating surface is made possible. The mechanical, chemical and performance properties of uncoated substrate are substantially exceeded by a substrate coated in this way.

### PRIOR ART

The inherent properties of PMMA, as of other thermoplastics, do not enable it to meet every requirement. It is sensitive to stress cracking, particularly after having been in contact with solvents such as, for example, acetone or aliphatic alcohols. Surface crazing occurs, which is a reason why Plexiglas surfaces must not be cleaned with alcohol or solvents. Although it is the case that PMMA is relatively scratch-resistant as compared with other mass-market plastics, there are nevertheless numerous applications where the scratch resistance is not sufficient.

As a result of surface enhancement, in the form, for example, of a coating of the surface of the PMMA, deficiencies can be largely removed and improvements in properties achieved. These coatings, while preserving the optical properties, are directed predominantly at increasing the scratch resistance in conjunction with self-cleaning properties, weathering stability, anti-reflection function and anti-graffiti effect. The enhanced scratch resistance in this case is generated directly by application of a hardcoat of double-bond-containing, polyfunctional, free-radically polymerizing and crosslinkable monomers and oligomers such as (fluoro)alkyl(meth)acrylates or silicon oxide SiOₓ, or melamine resin, or a pseudo-effect, through improved slip, is achieved on the surface through the use of acrylated polysiloxanes or waxes as an additive in the coating material. Coating modes which are prevalent include surface coating—also with UV curing and also with peroxide-initiated thermal curing, and plasma coating, calendering (EP 313979) and high-pressure roll processes (WO 9929766).

In accordance with EP 180129, anti-reflection coating is realized by means of porous silica particles in organosilicone polymers in (meth)acrylates or melamine resin of 1-40 μm coating thickness, with effects including the development of a rough, relatively matt surface. For producing a matt surface by means of a rough coating, WO 2008/059157 also proposes the use of methacrylate-based microparticles of different sizes and concentrations.

All of the known coatings and application methods have so far been unable to achieve a properties combination of deep-matt PMMA surface with good transparency, with very high abrasion resistance and scratch resistance, outstanding chemicals, weathering and UV resistance, good wettability and appealing tactility.

On an extensive basis, this surface enhancement can be achieved by coating with a clear coating agent. Particularly suitable for this purpose, in accordance with DE 10207401, is an acrylate coating agent which is reinforced with SiOₓ nanoparticles (nanocomposite coating agent), which is crosslinkable and polymerizable through ultraviolet radiation or electron beams and which, without substantially altering the optical properties of the PMMA base material, endows its surface with high abrasion resistance and scratch resistance, makes it resistant to solvents, and at least maintains its UV and weathering stability. This solvent-free nanocomposite coating agent possesses the advantage, moreover, that the surface of a coating of the coating agent can be microstructured by irradiation with shortwave UV light or electron beams, producing a matt appearance of this surface, with significantly increased mechanical and chemical resistances, and at the same time maintaining a high transparency, because the SiOₓ nanoparticles, in terms of their refractive index of 1.45, correspond approximately to that of the coating agent matrix, and the organophilisized particles are incorporated covalently into the coating agent matrix. In order to produce this topography through what is called the “photochemical microcreasing”, the sheetlike PMMA product, coated with a liquid nanocomposite coating layer, passes through the beam path of a 172 nm excimer VUV lamp under a nitrogen atmosphere. The VUV photons, which penetrate the coating layer only to a depth of a few hundred nm, cause the production, through photochemical polymerization or crosslinking—with no need for a photoinitiator, since acrylates absorb very well in this shortwave UV range, and the photon energy (7.2 eV) is very high—a thin skin, which crinkles as a result of polymerization-induced contraction stresses (DE 19842510). After the microcreasing procedure is complete, this skin still floats on a coating layer which continues to be liquid, and which is subsequently cured by longer-wave UV light in the presence of photoinitiator, or by means of electron beams, thereby fixing the creased skin and causing the coating as a whole to adhere to the substrate. The gloss level resulting from the microcreasing is dependent on the topography produced. The latter is determined essentially by the formulation of the coating agent, and can be varied within certain limits through the technological parameters (DE 102006042063). In addition to this generation of matt gloss, the high efficiency in double bond conversion and the additional generation of free radicals by the 172 nm photons, producing a higher degree of crosslinking as compared with conventional polychromatic UV curing, are of great advantage. A marked increase in the microhardness in the near-surface region of the coating, with positive consequences for the abrasion resistance and scratch resistance and also for improved barrier properties, is the consequence. The round combs of creases give rise to an appealing tactility, and the vacuum UV (VUV) light generates polar groups which enhance the hydrophilicity.

Good substrate adhesion of a solventlessly applicable and fully curable (meth)acrylate coating on PMMA is obtained, according to EP 245728 and DE 2928512, on a warm substrate.

### Problem

The problem addressed by the present invention was that of providing a method with which, on the basis of PMMA or other plastics substrates, it is possible to produce a semi-finished product which is uniformly matted.

The problem, furthermore, was to use this method to provide access to semi-finished products which have improved mechanical properties, such as, in particular, improved scratch resistance and abrasion resistance, and enhanced chemical resistance in conjunction with good UV and weathering stability.

Furthermore, there was a need for coatings which respond to the above problems and in addition exhibit very good substrate adhesion.

In addition, the problem existed of providing all of this by means of a method which can be carried out easily, quickly and with little energy.

Further problems, not explicitly addressed, will become apparent from the overall context of the description, claims and examples which follow.

### Solution

The problems are solved by an innovative method for the coating of plastics substrates, more particularly polymethyl(meth)acrylate surfaces. This method may be used more particularly for the coating of transparent polymethyl(meth)acrylate surfaces.

The method of the invention is a coating method with specific nanocomposite coating agents. The nanocomposite coating agent in this case comprises silicon oxide (SiOₓ) nanoparticles, at least one crosslinkable, acrylate- or methacrylate-based binder, at least one reactive diluent and optionally at least one thickener.

Surprisingly it has been found that the use of the method of the invention, with use of the likewise inventive nanocomposite UV coating agent containing SiOₓ nanoparticles, allows the production of transparent semi-finished products with high abrasion resistance and scratch resistance, with chemical, UV and weathering stability that are improved over the present state, or in conjunction with very good substrate adhesion by the coating, and good mechanical properties.

The nanocomposite coating agent in the method of the invention has, during application, a viscosity of between 500 mPas and 20 Pas, preferably between 6 Pas to 20 Pas and more preferably between 10 Pas and 18 Pas. At the same time, the polymer surface to be coated has a temperature of at least 40° C., more preferably at least 60° C., but not higher than the melting temperature or glass transition temperature of the polymer that is to be coated. In the case of a PMMA substrate, temperatures to be employed are between 35° C. and 120° C., preferably between 40° C. and 90° C. The coating agent may be applied either at room temperature or else in a form in which it has been preheated—to the respective substrate temperature, for example.

In a second step of the method, after coating has taken place, irradiation with shortwave UV light is carried out on the surface of the liquid coating layer to produce a thin skin which, after microcreasing in a subsequent, third method step, is fixed on the substrate by the curing of the overall nanocomposite coating by means of a second UV lamp which emits long wave light.

In particular, the first UV radiation is monochromatic 172 nm excimer VUV radiation. A preferred irradiation dose in this case is below 20 mJ·cm⁻². With this shortwave UV radiation, which penetrates only to a very low depth into the coating agent matrix, the coating, as a result of microcreasing of the surface, acquires matt optical properties, which means gloss values and tactility that is analogous to the state of the art. The second radiation source, preferably UV radiation source, may be, for example, a medium-pressure mercury lamp, with an output, for example, of 160 W·cm⁻¹ and an irradiation dose of 800 mJ·cm⁻², or an electron accelerator. After this final curing, the coating exhibits excellent adhesion to the substrate or, more particularly, to the semi-finished product.

The crosslinkable, (meth)acrylate-based binder of the nanocomposite coating agent is preferably a tri- or polyfunctional urethane acrylate oligomer or a mixture of different urethane acrylate oligomers comprising at least one tri- or polyfunctional urethane acrylate oligomer. It is preferably a polyfunctional urethane acrylate oligomer. Polyfunctional in this context means that the number of carbon double bond end groups per monomer unit is greater than or equal to 4, preferably greater than or equal to 6. An advantage of these urethane acrylate oligomers is that they exhibit virtually no yellowing on exposure to UV light, and, in cured form, exhibit high scratch resistance, characterized for example by the pencil hardness. Alternatively and preferably, the crosslinkable binder may also take the form of a mixture of the above-described polyfunctional urethane acrylate oligomers with a relatively low fraction of urethane acrylate oligomers of relatively low functionality, more particularly of a urethane acrylate oligomer having 2 to 3 carbon double bond end groups. A mixture of this kind exhibits improved flexibility and impact strength.

The reactive diluents which are used in accordance with the invention and are capable of reacting with the crosslinkable binder may preferably be acrylates. With particular preference the reactive diluent is 1,6-hexanediol diacrylate (HDDA).

The SiOₓ nanoparticles are silicon oxides with a value for x of between 1.6 and 2.0, preferably between 1.9 and 2.0. The silicon oxide nanoparticles may be present individually or as mixed oxides. On account of the transparency of the product, the particle size of these oxide particles ought to be situated within the nanometre range. The particles preferably have a size of 300 nm at most, and more particularly are situated within a range from 1 to 200 nm, preferably 1 to 50 nm.

The thickening additives optionally included are preferably (meth)acryloyl-functional polyetherdimethyl-siloxanes, such as BYK® UV-3500, for example. The nanocomposite coating agent comprises the thickening additive preferably at a concentration of between 0.1% and 5.0% by weight, preferably between 0.5% and 2.0% by weight. In spite of an already increased viscosity, the nanocomposite coating agents used in accordance with the invention are additionally admixed with thickening additives in order to give the coating agent a paste like consistency. As a result of this, following application of the coating material, the preliminary microstructure that has been generated by means of a structuring application method, as for example with a screen printing technology, remains stable even at temperatures up to 90° C.

The method of the invention may take place preferably directly following an extrusion operation for producing the substrate that is to be coated, more particularly the semi-finished product. With very particular preference the method is integrated in-line into the line for producing the substrate that is to be coated. In this way, with more particular preference, the production of the substrate or semi-finished product and the method for coating it can be carried out continuously.

The nanocomposite coating agent may be applied by means of screen printing, a roll-coater technology or another suitable structuring method. The nanocomposite coating agent is applied to the substrate surface preferably by means of rotary screen printing. In a further, preferred embodiment, operation takes place in a roll application method for coating with the nanocomposite coating agent, with a profiled application roll, or application with a smooth roll is followed by a profiled roll for structuring.

With these preferred embodiments of application methods selected, a high-viscosity coating agent can be applied, and this coating agent is thereby given a preliminary structure which remains stable even at the relatively high temperatures and which, following irradiation with the first radiation source, receives a superstructure which leads to the optical matting and to a tactually appealing surface with anti-fingerprint effect.

Part of the present invention, in addition to the method described, is also the nanocomposite coating agent which can be employed in this method and whose binder matrix is composed to an extent of 30.0% to 60.0%, preferably 35.0% to 55.0%, by weight of a polyfunctional urethane acrylate oligomer having ≧6 carbon double bonds per monomer unit, which exhibits virtually no yellowing on exposure to UV light and which in cured form possesses a high scratch resistance. The binder matrix further comprises 2.0% to 20.0%, preferably 5.0% to 15.0%, by weight of a likewise UV-stable urethane acrylate oligomer of lower functionality, having 2 to 3 carbon double bonds per monomer unit, for flexibilization and to increase the impact strength. In addition, the binder matrix has a reactive diluent fraction—preferably 1,6-hexanediol diacrylate (HDDA) for exterior application—of 10% to 50%, preferably of 20% to 40%, by weight.

This coating agent formulation is modified in an in situ method in analogy to DE 10207401, in which silicon dioxide nanoparticles with a fraction of 1.0% to 15.0%, preferably of 3.0% to 12.0% and more preferably of 5.0% to 10.0% by weight are covalently bonded via a hydrolysis step of a silane, e.g. Dynasylan VTMO® from Evonik Degussa GmbH. The silane, preferably a (meth)acryloyl-functional silane, may be present at between 1.0% and 10.0%, preferably between 2.5% and 7.5%, by weight. For final curing of the coating after the excimer-VUV-initiated microcreasing, not more than 5.0%, preferably not more than 3.5%, by weight of a mixture of no- to low-yellowing photoinitiators is added and the coating agent is provided additionally, for UV protection, with 1.0% to 3.0% by weight of a UV absorber and 0.5% to 2.5% by weight of a HALS additive (hindered amine light stabilizer). Added additionally to the coating agent is a thickening additive, e.g. BYK-UV 3500, with a fraction of between 0.1% and 5.0%, preferably between 0.2% and 2.5%, by weight, in order to achieve the final pastelike rheology. The effect of this, when the substrate is coated by means of a structuring application method, such as with a screen printing technology, for example, is that the preliminary microstructure generated remains stable even at temperatures of up to 90° C. Through subsequent irradiation of this preliminarily structured PMMA coating using 172 nm excimer VUV radiation, with an irradiation dose <20 mJ·cm⁻², the surface, as a result of superimposed microcreasing, acquires matt optical properties, in other words gloss values and tactility which correspond approximately to those of a standard commercial matted semi-finished PMMA product, such as PLEXIGLAS Satinice® from Evonik Röhm GmbH, for example. After final curing with a medium-pressure mercury lamp, with a sufficient irradiation dose, the coating combines excellent adhesion to ISO 2409:1992 (GT 0) with a very high pencil hardness, and the abrasion resistance as well, tested with the TABER 5151 ABRASER to ASTM D-1003 and D-1044 with CS10 F, and assessed according to the change in haze, is excellent after 100 revolutions with a 500 g load, with a very small change in haze. Correspondingly good are the chemical, UV and weathering resistance as well.

If thermoplastic shaping of the rigid semi-finished PMMA products necessitates greater flexibility of the coating, which undergoes only stretching or compression in the course of such shaping, this can be achieved through modifying the proportions of oligomer, at the expense of the scratch resistance and abrasion resistance.

Additionally part of the present invention are the coated semi-finished products which can be produced, and preferably are produced, by means of the method of the invention. Coated semi-finished products of this kind may find use, for example, in shopfitting, trade-fair construction or furniture construction, as covers for lamps and lights, as picture glazing, in advertising signs and street signs, or as surfaces of touch screens or photovoltaic modules, without this recitation having any capacity whatsoever to impose a restriction on the present invention.

Semi-finished products for the purposes of this invention are prefabricated, raw material shapes. They may be, for example, rods, pipes, plates or, in particular, thin sheets.

### EXAMPLES

The examples which follow serve for illustration and for better understanding of the present invention, but do not restrict it in any way with regard to its scope or area of application.

Below, a semi-finished product coated with a nanocomposite coating agent of the invention is compared with a PLEXIGLAS Satinice® sample from Evonik Röhm GmbH as comparative example. The composition and dimensions of the semi-finished PMMA product are exactly the same.

The coating agent was applied by screen printing.

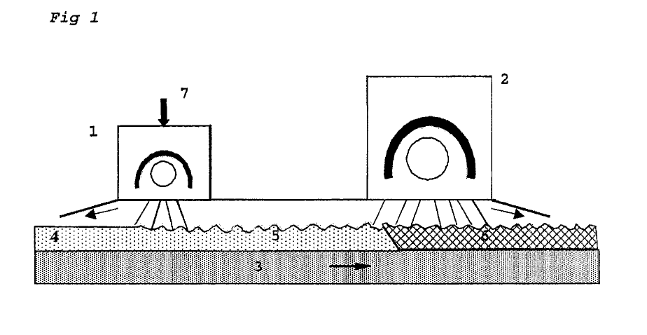

Two nanocomposite coating agents with the same matrix composition, as evident from Table 1, differing only in the proportion of the thickening additive, were applied by means of a 120-34Y screen in an average coat thickness of 7-9 μm to sample plates which had been preheated to 60° C. or to 90° C., and in this way a preliminary structure was generated. After a residence time of not more than one minute, the surface of the coatings was microcreased by the methodology of the invention, in accordance with FIG. 1, in the inertized irradiation tunnel—with a residual oxygen content of less than 70 ppm—initiated by a 172 nm excimer VUV dose of 4.5 mJ·cm-2, after which the coating as a whole was given a final cure with a UV dose of 800 mJ·cm-2 from a medium-pressure mercury lamp.

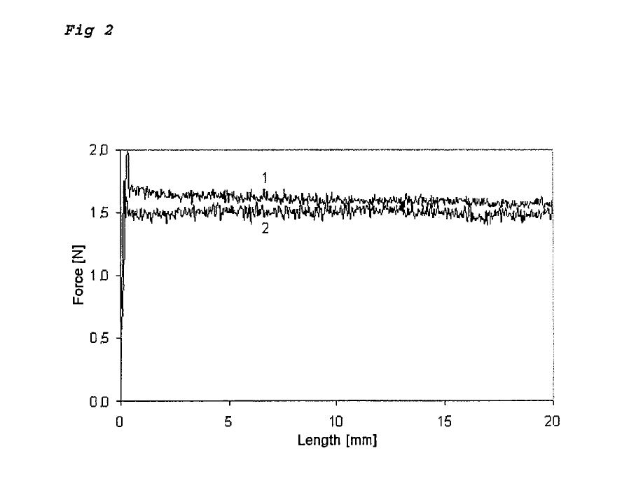

The surface properties of the two examples and of a comparative example (PLEXIGLAS Satinice®) are shown in Table 2 and also in FIG. 2. From Table 2 it is quite clear that, in spite of different topographies of the microcreasing and of the surface structure, obtained by moulding, of the PLEXIGLAS Satinice®, gloss values are achieved that are in good approximation the same, with a substantial improvement in the mechanical resistance values and in the UV and weathering stability as a result of the coating. From FIG. 2 it is evident that the coefficients of surface friction and the resulting trends of both structures are approximately the same, which may be considered a criterion for similar tactility. The comparison of the two batches also illustrates the great importance of the thickening additive, in this case BYK UV 3500, in the coating of a hot substrate.

Although a higher concentration of additive does reduce the risk of the preliminary structure running between application and commencement of the microcreasing operation at elevated temperature (90° C.), as reflected in approximately constant gloss values at 85° measurement geometry, the greater proportion does result in a reduction in the scratch resistance.

TABLE 1
Composition, examples

| | | Example 1 | Example 2 |
|---|---|---|---|
| | Substance | Weight | Weight |
| | name | fractions | fractions |
| | (trade name) | [% by wt.] | [% by wt.] |
| polyfunctional urethane | DM 5812 | 39.72 | 39.30 |
| acrylate | | | |
| difunctional urethane | DM 570 | 7.95 | 7.86 |
| acrylate | | | |
| reactive diluents | HDDA | 31.78 | 31.44 |
| silane | Dynasylan VTMO | 4.49 | 4.44 |
| silanization auxiliaries | maleic | 1.87 × 10⁻² | 1.85 × 10⁻² |
| | anhydride | | |
| | 4-methoxy- | 1.87 × 10⁻¹ | 1.85 × 10⁻¹ |
| | anisole | | |
| SiOₓ nanoparticles | Aerosil A380 | 9.35 | 9.25 |
| photoinitiator mixture* | Darocure 1173 | 2.00 | 3.00 |
| | Irgacure 184 | 1.00 | |
| UV absorber | Tinuvin 400 | 2.00 | 2.00 |
| HALS | Tinuvin 123 | 1.00 | 1.00 |
| thickening additive | BYK UV 3500 | 0.50 | 1.5 |

*obtained from Cetelon Nanotechnik GmbH

TABLE 2
Comparison of optical and mechanical surface
properties

| Criteria for | | | | |
|---|---|---|---|---|
| assessment and | | | | |
| comparison of surface | | Comparative | | |
| properties | | example | Example 1 | Example 2 |
| Coating agent adhesion | | none | 0 | 0 |
| test GT | | | | |
| Coating at | 60° C. | 2 | 3 | 2 |
| | 20° | 10 | 11 | 10 |
| Gloss values | 60° | 5 | 6 | 5 |
| | 85° | | | |
| Coating at | 90° C. | 2 | 3 | 2 |
| | 20° | 10 | 13 | 9 |
| Gloss values | 60° | 5 | 23 | 3 |
| | 85° | | | |

| | | | |
|---|---|---|---|
| Abrasion resistance | 6 | 0.3 | 1.7 |
| Δ haze [%] | | | |
| Scratch resistance [N] | 1 | 2.5 | 1.5-1.8 |
| UV and weathering | | | |
| stability after | 0.7 | 0.0 | not |
| 3000 h | not | 0.1 | available |
| Δ L* | available | | not |
| Δ b* | | | available |

GT = adhesion testing by means of crosshatch test and tesa test in accordance with DIN EN ISO 2409:2007, with values between 0 (total adhesion) and 5 (complete delamination)
gloss values in gloss points, measured at angles of 20°, 60° and 85° to the vertical, in accordance with DIN 67 530:1982, DIN ISO 2813:1999, ASTM D 523-08 and D 2457-08. The gloss values were determined by means of a Haze Guard plus (from Byk Gardner).
The abrasion resistance was determined using a TABER 5151 ABRASER in accordance with standards ASTM D 1044-7 and 1003-7 with the CS10F specification, with a weighting of 500 g, after 100 revolutions, as the change in haze, using the BYK Gardner haze-guard plus spectrometer.
The scratch resistance was determined using an Erichsen 413 scratch tester in accordance with DIN EN 438-2:2005.
The UV and weathering stability were tested in a QSUN/1000 xenon test apparatus in accordance with DIN EN ISO 11341:2004 in a continuous 3000 h test, the criterion for measurement being the change in colour.

The results show that this inventive produced semi-finished product in comparison with the best known state of the art, with similar matt gloss values, which can be varied if desired, and likewise with good tactility and good remanant transparency, exhibits enhanced scratch and abrasion resistance and significantly improved chemical resistance in conjunction with comparable weathering stability.

There follows 1 sheet with 2 drawings

FIG. 1: Technological scheme of photochemical micro-creasing

The labelling figures have the following meanings:

1: 172 nm excimer lamp
2: medium-pressure mercury lamp
3: substrate (or semi-finished product to be coated)
4: liquid coating
5: creased skin (surface-crosslinked coating with microcreasing)
6: cured coating
7: inert gas (N₂) supply line

FIG. 2: Surface friction characteristics of two equal structures of the comparative example and of Example 1, as a criterion for the comparison of tactility

1: comparative example
2: Example 1

1: A method for coating a plastic surface with a nanocomposite coating agent, the method comprising:
applying a nanocomposite coating agent having a viscosity of between 6 Pas and 20 Pas to a substrate surface having a temperature of between 35° C. and 120° C.; then
curing the nanocomposite coating agent on the substrate surface with a first UV radiation which is shortwave UV light, such that microcreasing occurs; and then completely curing the nanocomposite coating agent with a second UV lamp, to form a coating on the substrate surface,
wherein the nanocomposite coating agent comprises:
SiOₓ nanoparticles;
at least one highly crosslinkable binder; and
at least one reactive diluent.

2: The method according to claim 1, wherein the nanocomposite coating agent further comprises at least one thickener.

3: The method according to claim 1, wherein the first UV radiation is a monochromatic 172 nm excimer VUV radiation.

4: The method according to claim 1, wherein the reactive diluent is an acrylate.

5: The method according to claim 1, wherein the highly crosslinkable binder is a tri- or polyfunctional urethane acrylate oligomer or a mixture of different urethane acrylate oligomers comprising at least one tri- or polyfunctional urethane acrylate oligomer, said polyfunctional acrylates being such that a number of carbon double bond end groups per monomer unit is greater than or equal to 4.

6: The method according to claim 2, wherein the thickener is a (meth)acryloyl-functional polyetherdimethylsiloxane.

7: The method according to claim 6, wherein the nanocomposite coating agent comprises a concentration of between 0.1% and 5.0% by weight of the thickener.

8: The method according to claim 1, wherein the substrate surface has a temperature of between 40° C. and 90° C. during the applying of the nanocomposite coating agent.

9: The method according to claim 1, further comprising, before the applying of the nanocomposite coating agent to the substrate surface, an extrusion to form a substrate comprising the substrate surface to be coated.

10: The method according to claim 9, wherein:
a line for implementing the method is integrated in-line into a line for producing the substrate comprising the substrate surface to be coated; and
the method and production of the substrate occur continuously.

11: The method according to claim 1, wherein the nanocomposite coating agent is applied to the substrate surface with a structuring continuous coating method.

12: The method according to claim 11, wherein:
the structuring continuous coating method is a roll-coater method; and
a coating roll for the nanocomposite coating agent is profiled or an application with a smooth roll is followed by a profiled roll for preliminary coating agent structuring.

13: A nanocomposite coating agent comprising:
0.1% to 5.0% by weight of a thickening additive;
35.0% to 55.0% by weight of a polyfunctional urethane acrylate oligomer, said polyfunctional acrylate comprising a number of carbon double bond end groups per monomer unit of greater than or equal to 4;
5.0% to 15.0% by weight of a di- or trifunctional urethane acrylate oligomers;
3.0% to 12.0% by weight of SiOₓ nanoparticles; and
20% to 40% by weight of reactive diluent.

14: The coating agent according to claim 13, which is suitable for applying to a semi-finished polymethyl(meth)acrylate article, such that:
the coating agent has a viscosity of between 6 Pas and 20 Pas, and the semi-finished polymethyl(meth)acrylate article has a temperature between 30° C. and 120° C., during the applying;
the nanocomposite coating agent on the substrate surface is then cured with a first UV radiation which is shortwave UV light, such that microcreasing occurs; and
the nanocomposite coating agent is then completely cured with a second UV lamp, to form a coating on the substrate surface.

15: A coated semi-finished article obtained by the method according to claim 1.

16: The method according to claim 1, wherein the substrate surface is a transparent or non-transparent polymethyl(meth)acrylate surface.

17: The method according to claim 4, wherein the reactive diluent is 1,6-hexanediol diacrylate (HDDA).

18: The method according to claim 5, where said polyfunctional acrylates are such that a number of carbon double bond end groups per monomer unit is greater than or equal to 6.

19: The method according to claim 7, wherein the nanocomposite coating agent comprises a concentration of between 0.5% and 2.0% by weight of the thickener.

20: The method according to claim 11, wherein structuring continuous coating method is a rotary screen printing method or a roll-coater method.
